(19) United States
(12) Patent Application Publication
(10) Pub. No.: US 2010/0188189 A1
(43) Pub. Date: Jul. 29, 2010

(54) SAFETY SYSTEM FOR CONTROL OF THE ACCESS TO AN OBJECT

(75) Inventors: Heiko Bald, Modautal (DE); Aiko Boehme, Ingelheim (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/523,527

(22) PCT Filed: Jan. 17, 2007
(86) PCT No.: PCT/EP2007/000348

§ 371 Date: Mar. 26, 2010

(51) Int. Cl. G07C 9/00; G05B 19/00

(52) U.S. Cl. 340/5.6

(57) ABSTRACT

A safety system is provided for control of the access to an object with a lock, that can alternatively be locked or unlocked by a mechanical key subsystem and by a remote control key subsystem offers the possibility to intentionally deactivate a remote control key subsystem by using for example the mechanical key subsystem when locking the object. Later, the remote control key subsystem can be reactivated by using the mechanical key subsystem again for unlocking. This way, the use of the remote control key subsystem can be prevented in situations where a theft of a remote control key is more probable than in other situations.

### CROSS-REFERENCE TO RELATED APPLICATIONS

This application is a U.S. National-Stage entry under 35 U.S.C. § 371 based on International Application No. PCT/EP2007/000348, filed Jan. 17, 2007, which was published under PCT Article 21(2), which is hereby incorporated in its entirety by reference.

### TECHNICAL FIELD

The present invention relates to a safety system, in particular to a locking system for a car. It also relates to safety systems for other vehicles, houses and garages.

### BACKGROUND

In former times, access to an object was usually controlled by a mechanical lock and a mechanical key system was used for locking and unlocking By using special keys, copying the keys and illegal access to the object could mostly be prevented.

Nevertheless the keys had to be protected and with some effort it was nevertheless sometimes possible to copy keys or to steal them.

Modern access control systems often also include remote control key systems to control the access to an object or to lock and unlock an electronical lock respectively.

Use of a remote control key subsystem usually requires a coding of the key to enable the system to identify the holder/user of a remote control key.

Copying of such a remote control key may sometimes be more difficult than copying a mechanical key and using a remote control key system is mostly much more comfortable than using a mechanical key.

In some modern systems mechanical key subsystems and remote control key subsystems are combined to realize the advantages of both systems.

For example, for cars usually mechanical keys are still applicable and at the same time most cars have a remote control key subsystem to open and close the doors and activate/deactivate access to the driving unit or to the steering wheel. Usually the driver has the choice either to use the mechanical key or the remote control key. Such systems are also applicable to houses, garages or other vehicles than cars.

The use of remote control key systems can also lead to problems, as is for example shown in DE 10227804 A1. There, the problem is explained, that the key of a remote control key system can be forgotten in the car and would thereby be accessible to a possible thief. An automatic system is used for deactivating the key forgotten inside the car.

But also still other problems can occur with remote control key systems, where for example the key of such a system is stolen and the thief cannot necessarily identify the object that can be opened or activated by the key. With a mechanical key, the thief would have to try out the key to any object he can find.

With a remote control key that has an operating distance up to some tens of meters, the thief can move along using the remote control key and observing if any object is responding. For example, cars mostly give optical or acoustical signals when a respective remote control key is activated. [0011] Accordingly, it is desirable to provide a safety system for control of the access to an object by locking and unlocking a lock with a mechanical key subsystem and a remote control key subsystem. In addition, other desirable features and characteristics will become apparent from the subsequent summary and detailed description, and the appended claims, taken in conjunction with the accompanying drawings and this background.

### SUMMARY

The safety system according to an embodiment of the present invention allows for control of the access to an object by locking and unlocking a lock. Such an object, that is protected by a lock, can basically be a vehicle, for example a car or a motorcycle, or a house, for example a garage.

The safety system according to an embodiment of the invention comprises a mechanical key subsystem, for example with a mechanical key as is known for the doors or the ignition system of a car or for the door of a house. Corresponding to the respective key is a mechanical lock on the object. When the lock is operated by the key, access to the object is given or denied. The key can serve to lock or unlock the mechanical lock.

The safety system also comprises a remote control key subsystem, comprising a first communication unit fixed to the object and a second communication unit which is mobile. Such a remote control key subsystem is known from the use with cars that can be opened by a mobile device via radio control or from a lock of a garage that can be opened also by a remote control key system by the car driver sitting in a car outside the garage.

An advantage of the safety system follows from the feature that the remote control key subsystem can be deactivated intentionally.

This feature allows the ability to switch off the remote control key subsystem in cases where there is a special risk that such a remote control key subsystem could be misused by other persons that do not have the right of access to the object.

For example, when visiting public locations, a second communication unit which is mobile and which can for example be a transponder for a car can easily be stolen. In this case, it would be easy for a thief to use the second communication unit and try to reach a car which is close enough for a communication between the first communication unit and the second communication unit. Most cars show that a remote control key subsystem has been used by flashing with the front and rear lights or by giving an acoustical signal. In this way, the thief could easily find the car to which the stolen remote control key fits. He or she can go along the rows of parked cars and can easily find the respective car.

The safety system according can prevent such a proceeding by giving the driver the opportunity to switch off the remote control key subsystem.

The same as with cars could happen with keys that fit to a house door or to a garage door. A possible thief could drive through the streets of a city using the remote control key to try out if he finds the respective house to which the remote control key fits.

As usually in normal situations the safety system should be usable either with the mechanical key subsystem or with the remote control key subsystem, it is an advantage to reactivate the remote control key subsystem as soon as possible after the situation where it had been deactivated is over.

The reactivation can happen either by using the mechanical key subsystem to get access to the object or by using a digital access code input to the second communication unit, to the first communication unit or to the lock.

The invention has the advantage that a thief would have to try out the mechanical key subsystem on a lot of objects to find out to which object the stolen key fits. Only after having found the respective object he/she could reactivate the remote control key subsystem for example by using a mechanical key. The other alternative, input of a digital access code to said second communication unit etc., is also an advantage for the proprietor of the object or the person who is entitled to access to the object as he can keep the digital access code secret so that the remote control key subsystem cannot be reactivated at all by a thief.

There are different methods for deactivating the remote control key subsystem, either by using the mechanical key subsystem for locking the lock or using a mechanical switch fixed to the object wherein the mechanical switch can be installed inside the object or outside the object. If the mechanical switch is installed inside the object, the access to the switch is impossible to a person who has no access to the object. If the switch is installed outside the object the access to the switch is not prevented so that a person with access to the object can use the switch as well as a person without access to the object. It has however to be kept in mind that the switch is only for deactivating the remote control key subsystem and cannot be used for reactivating the system.

The deactivation of the remote control key subsystem can generally mean that the first communication unit in the remote control key subsystem is switched off or that the second communication unit is switched off or that the first communication unit after deactivating ignores demands from the second communication unit.

Deactivating the system may also mean that simply the second communication unit is switched off which can be done easily by a switch installed on the second communication unit itself. The second communication unit itself can also comprise a keyboard for input of the access code so that deactivating and reactivating the remote control key subsystem can be done using said second communication unit.

### BRIEF DESCRIPTION OF THE DRAWINGS

The present invention will hereinafter be described in conjunction with the following drawing figures, wherein like numerals denote like elements, and:

FIG. 1 shows a schematic view of the safety system in accordance with an embodiment of the invention;

FIG. 2 shows a schematic view of an alternative embodiment of the invention;

FIG. 3 shows a schematic view on another alternative embodiment of the invention;

FIG. 4 shows a schematic view of another alternative of the invention;

FIG. 5 shows an embodiment of the invention used for a car;

FIG. 6 shows a schematic view of a car with a build-in safety system according to an embodiment of the invention;

FIG. 7 shows a flowchart of the process used by the safety system according to an embodiment of the invention.

### DETAILED DESCRIPTION

The following detailed description is merely exemplary in nature and is not intended to limit application and uses. Furthermore, there is no intention to be bound by any theory presented in the preceding background and summary or the following detailed description

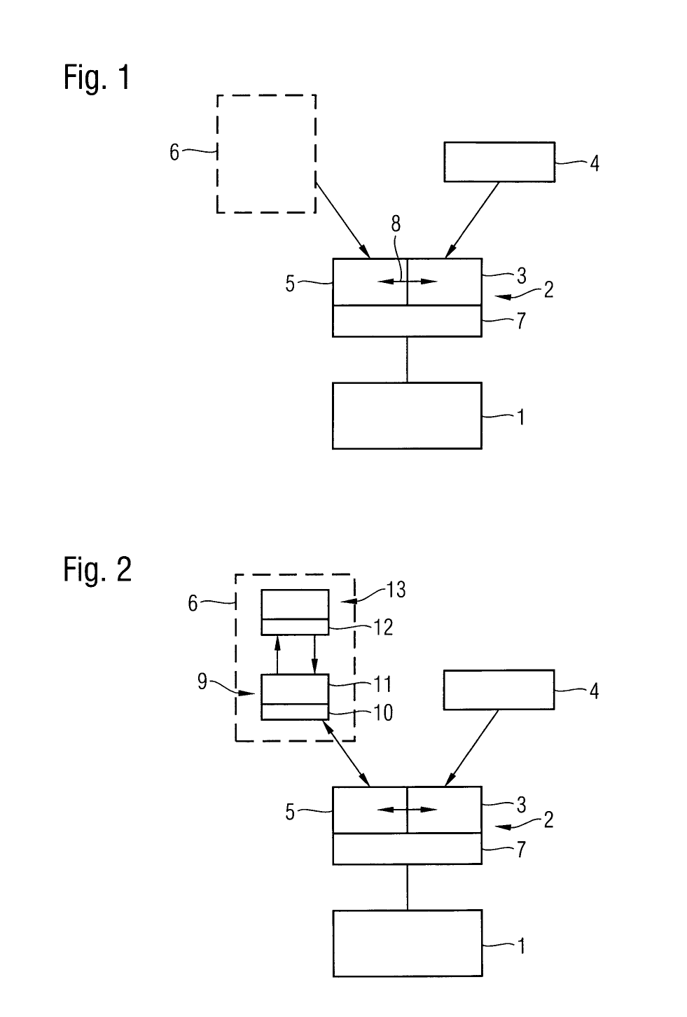

FIG. 1 shows a schematic view of important parts of the safety system, said safety system being used for control of the access to an object 1. The object 1 can be either a car or another vehicle or a steering unit for the motor of a car or a house or a garage.

The object is protected by a lock 2 which can be locked and unlocked. The lock comprises two parts, the mechanical part 3 being operable with a mechanical key subsystem 4 and the remote control part 5 being operable by a remote control key subsystem 6. Both, the mechanical part 3 and the remote control part 5 of the lock 2 can act on a lock mechanism 7 that locks or unlocks access to the object 1.

On one hand it is possible to lock or unlock said lock mechanism 7 by using the mechanical part 3 of the lock 2 and the mechanical key subsystem 4. On the other hand it is possible to lock and unlock said lock mechanism 7 by using the remote control part 5 and the remote control key subsystem 6.

Generally it is also possible to lock said lock mechanism 7 by the mechanical part 3 and the mechanical key subsystem 4 and unlock said lock mechanism 7 by the remote control part 5 and the remote control key subsystem 6 and vice versa.

By the arrow 8 it is shown that the mechanical part 3 and the remote control part 5 of the lock 2 communicate with each other. Therefore, using the mechanical key subsystem 4 for locking said locking mechanism 7 the remote control part 5 or the remote control key subsystem 6 can be deactivated. This can generally be provided each time the mechanical part is used for the lock 2. It can particularly be provided that by locking said locking mechanism 7 mechanically, the remote control part 5 or the remote control key subsystem is deactivated and by using the mechanical key subsystem 4 and the mechanical part 3 of the lock 2 respectively for unlocking the locking mechanism 7 the remote control part 5 and/or the remote control key subsystem 6 is reactivated.

To show how the deactivation and reactivation of the remote control key subsystem works, FIG. 2 shows the lock 2 and the remote control key subsystem 6 in more detail.

FIG. 2 shows that the remote control key subsystem 6 comprises a first communication unit 9 with an actor unit 10 and a radio unit 11. The radio unit 11 of the first communication unit communicates with a radio unit 12 of the mobile second communication unit 13.

In general use, a lock command or an unlock command from said second communication unit 13 is transmitted by the radio unit 12 to the radio unit 11 of the first communication unit and then transformed into an action of the actor unit 10 to the lock 2 in order to lock or unlock the lock mechanism 7.

Said second communication unit 13 can for example be a remote control key of a central locking system of a car. The lock 2 can be a lock or central locking system for the car doors or a lock for the steering module of the driving system of a car.

According to an embodiment of the invention, the lock can be manipulated in order to deactivate the remote control key subsystem, for example by deactivating said first communication unit 9 or said second communication unit 13.

The remote control key subsystem can also be deactivated by transferring the lock 2 into a status where it ignores commands from the first communication unit 9 or actor 10.

The reactivation of the lock 2 to accept commands from said first communication unit or the reactivation of the first communication unit 9 or the second communication unit 12 can be initiated by using the mechanical key subsystem 4 on the lock 2.

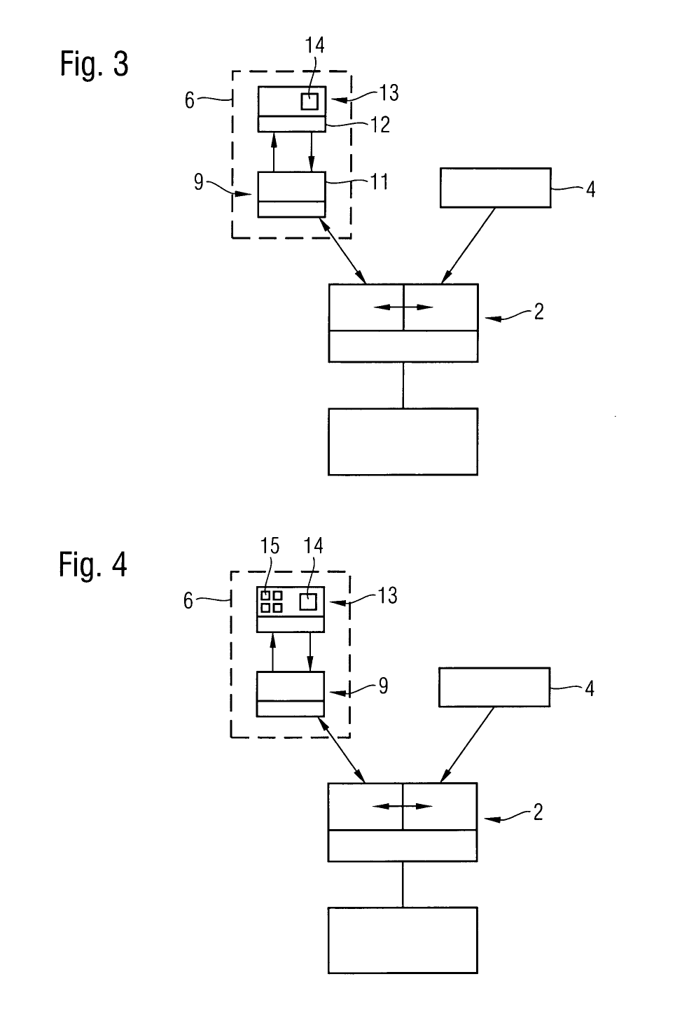

FIG. 3 shows another mechanism for deactivating the remote control key subsystem.

Basically, the structure of the FIG. 3 is similar to that shown in FIG. 2, except that the second communication unit 13 comprises a switch 14 allowing for switching off said communication unit 13. The switch 14 cannot be used for reactivating the second communication unit 13. For that purpose, again the use of the mechanical key subsystem 4 is necessary. If the mechanical key is used on the lock 2, a command is given from the lock to the first communication unit 9 which sends a command from radio unit 11 to the radio unit 12 of the second communication unit 13 to reactivate it.

If deactivating the remote control key subsystem means only to deactivate the first communication unit 9, it can be reactivated by using the mechanical key subsystem 4 on the lock 2. In this case, a command is sent to the first communication unit 9 to reactivate it.

FIG. 4 shows another embodiment of the invention with a second communication unit 13 comprising a switch 14 for switching off or deactivating the second communication unit or generally deactivating the remote control key subsystem. The second communication unit 13 further comprises a keyboard 15 allowing for input of a digital code to reactivate said second communication unit 13 or generally to reactivate said remote control key subsystem.

The keyboard can comprise the keys that are usually provided on a central locking system remote control key for a car (i.e., one key for closing the doors), one key for opening the doors and one key for opening the trunk of the car. The digital code can for example consist of a combination of these three keys, wherein each of the keys can be linked to a number of letters making it possible to memorize the digital code by linking it to a password.

This embodiment of the invention can be operated as followed: when leaving the car and having locked it, the remote control key subsystem can be switched off or deactivated by pushing the switch 14 or by putting in a first digital code into the keyboard 15. From that time on, the safety system can only be used with the mechanical key subsystem to operate the lock 2.

So, a thief, who has stolen the remote control key, cannot use it to find the car to which it fits.

The legal owner or user of the car can nevertheless put in the right digital code to reactivate the remote control key subsystem or the second communication unit 13 respectively.

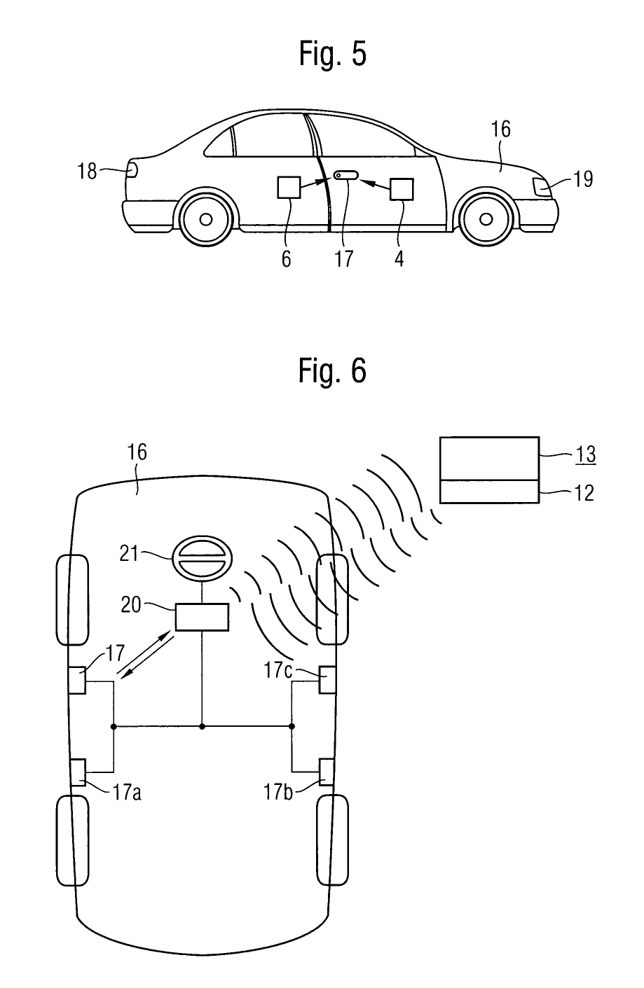

FIG. 5 shows schematically the embodiment of the invention used for the doors of a car 16 with a car lock 17, a mechanical key subsystem 4 and a remote control key subsystem. When the remote control key subsystem is used for locking or unlocking said car door lock 17, the lights 18, 19 of the car give a flash signal.

FIG. 6 shows a schematical view on a car 16 with four locks 17, 17a, 17b, 17c which form part of a central locking system of a car. The safety system 20 comprising at least parts of the remote control key subsystem and the mechanical key subsystem is linked to the lock 17 by wire or by a bus connection or a radio connection. The second communication unit 13 with the radio unit 12 communicates with the safety system 20 central unit by radio waves. So a command for opening or closing (i.e., locking or unlocking, from the key 17 can be transmitted to the safety unit 20). In addition, or alternatively, the safety system 20 is linked to a steering unit 21 for the motor of the car. So, the safety system can also be used for controlling the access to the motor of the car.

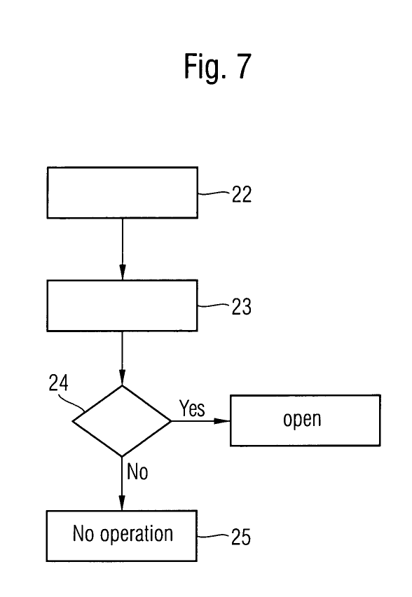

FIG. 7 schematically shows a flowchart of the process of locking or unlocking the lock in one embodiment of the invention where the remote control key subsystem is deactivated and reactivated by using the mechanical key on the lock 2.

In a first step 22, the mechanical key subsystem is used for locking the lock 2. One of the consequences is that the remote control key subsystem is deactivated in the second step 23. In a third step, 24, the lock 2 receives a command to unlock. It is first decided if the unlock command comes from the mechanical key subsystem 4. If the answer is yes, it is opened. If the answer is no, the lock is kept locked. At the same time, in the step 25, a signal can be put out to a user, saying that the remote control key subsystem cannot be used in this status. This signal should nevertheless be shown in a discrete way so that it cannot be used to find the car from a remote position when using the remote control key subsystem.

If the lock 2 is locked by the remote control key subsystem, the step 23 is not passed and in step 24 the lock is opened in any case by using either the mechanical key subsystem or the remote control key subsystem.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A safety system for control of the access to an object by locking and unlocking a lock, comprising:
a mechanical key subsystem; and
a remote control key subsystem, said remote control key subsystem comprising a first communication unit fixed to the object and a second communication unit that is mobile,
wherein the remote control key subsystem can be deactivated intentionally and wherein the remote control key subsystem can be reactivated by using the mechanical key subsystem on the lock.

2. A safety system according to claim 1,
wherein the remote control key subsystem is deactivated by using the mechanical key subsystem for locking said lock.

3. A safety system according to claim 1,
wherein the remote control key subsystem is deactivated by using a mechanical switch fixed to the object.

4. A safety system according to claim 1,
wherein the remote control key subsystem is deactivated by using a mechanical switch fixed to the object and accessible only when the object is accessible.

5. A safety system according to claim 1,
wherein the remote control key subsystem is deactivated by using it to transmit a deactivation command to the first communication unit.

6. A safety system according to claim 1,
wherein the remote control key subsystem is deactivated by deactivating the first communication unit with a command sent from the second communication unit.

7. A safety system according to claim 1,
wherein the remote control key subsystem is deactivated by an input to the second communication unit and wherein said input deactivates said second communication unit.

8. A safety system according to claim 1,
wherein said object is a vehicle.

9. A safety system according to claim 1,
wherein said object is a car.

10. A safety system according to claim 1,
wherein said object is the motor of a vehicle.

11. A safety system according to claim 1,
wherein said object is a house or a garage.

12. A safety system for control of the access to an object by locking and unlocking a lock, comprising:
a mechanical key subsystem; and
a remote control key subsystem, said remote control key subsystem comprising a first communication unit fixed to the object and a second communication unit which is mobile,
wherein the remote control key subsystem can be deactivated intentionally and wherein the remote control key subsystem can be reactivated by using a digital access code input to said second communication unit.

13. A safety system according to claim 12,
wherein the remote control key subsystem is deactivated by using the mechanical key subsystem on the lock of the object.

14. A safety system according to claim 12,
wherein the remote control key subsystem is deactivated by using a mechanical switch fixed to the object.

15. A safety system according to claim 12,
wherein the remote control key subsystem is deactivated by using it to transmit a command to the first communication unit with the effect that the first communication unit does not react to further commands from said second communication unit.

16. A safety system according to claim 12,
wherein the remote control key subsystem is deactivated by switching off said second communication unit.

17. A safety system according to claim 12,
wherein said object is a vehicle.

18. A safety system according to claim 12,
wherein said object is a car.

19. A safety system according to claim 12,
wherein said object is the motor of a vehicle.

20. A safety system according to claim 12,
wherein said object is a house or a garage.
